(19) United States
(12) Patent Application Publication
(10) Pub. No.: US 2018/0147816 A1
(43) Pub. Date: May 31, 2018

(54) METAL PLATE LAMINATING RESIN FILM, RESIN LAMINATED METAL PLATE, AND CONTAINER AND CONTAINER LID USING SAME

(71) Applicant: TOYO KOHAN CO., LTD., Tokyo (JP)

(72) Inventors: Hiroyuki IWASHITA, Tokyo (JP); Satoshi KAWAMURA, Kudamatsu-shi (JP); Takahiko MIYAZAKI, Kudamatsu-shi (JP)

(21) Appl. No.: 15/880,981

(22) Filed: Jan. 26, 2018

Related U.S. Application Data
(62) Division of application No. 15/110,221, filed on Jul. 7, 2016.

(30) Foreign Application Priority Data
Jan. 17, 2014 (JP) 2014-006633

(51) Int. Cl. B32B 15/09; B32B 1/02; B32B 7/12; B32B 15/18; B32B 27/30; B32B 27/36; B65D 25/14; C08L 67/02; B32B 15/085; B32B 27/08; B32B 15/20; B32B 27/32

(52) U.S. Cl. CPC B32B 15/09; B32B 2255/10; B32B 7/12; B32B 2439/70; B32B 2435/02; B32B 2307/4026; B32B 2255/26; B32B 15/18; B32B 27/302; B32B 27/36; B32B 2307/714; B32B 2439/40; B65D 25/14; B32B 2307/54; C08L 67/02; B32B 2307/732; B32B 15/085; B32B 2439/66; B32B 27/08; B32B 15/20; B32B 2270/00; B32B 27/32; B32B 1/02

(57) ABSTRACT

A resin film for laminating on metal sheet is provided which is composed of a polyester resin having such a mechanical property that a true stress at which a true strain of 1.0 as measured at 45° C. is obtained is 13 to 40 MPa. In addition, a resin film for laminating on metal sheet is provided in which the polyester resin is a material obtained by blending of a polytrimethylene terephthalate resin and a polybutylene terephthalate resin (PTT resin content: 20 to 80 mass %) or a two-layer resin film of a polyester resin and a polyethylene terephthalate resin, wherein the thickness of the polyester resin layer is not less than one half the total resin layer thickness.

### TECHNICAL FIELD

The present invention relates to a resin film for laminating on metal sheet having extremely high workability and applicable to uses where the resin film is subjected to severe working, such as drawing process, drawing and ironing process, thinning and drawing process, and, further, ironing process after thinning and drawing process, a resin laminated metal sheet, and a container and a container lid in which the resin laminated metal sheet is used.

### BACKGROUND ART

Conventionally, as containers such as beverage cans, there have been widely used those formed from a material by subjecting the material to drawing process, drawing and ironing process, thinning and drawing process, and, further, ironing process after thinning and drawing process, where the material is subjected to severe working, for the purpose of lightening the weight of cans or enlarging the internal volume of the cans by reducing the container wall thickness.

In these containers, metal sheets preliminarily laminated with a resin film are applied as material for containers subjected to the above-mentioned severe working, for the purposes of securing corrosion resistance to the contents, reducing the painting cost, excluding environmental pollution due to scattering of solvent during a painting step, and the like.

In the resin laminated metal sheets used for applications where the above-mentioned severe working is conducted, in general, a thermoplastic polyester resin is biaxially stretched, followed by heat fixing, and the resulting biaxially oriented film is used to be laminated on a metal sheet by use of a heat fusion method.

When these biaxially oriented films are put to measurement of mechanical properties by use of a tensile tester (TENSILON), in their state before lamination onto a metal sheet, a characteristic property of being high in yield strength and being small in elongation (elongation at break) is generally obtained.

When such a biaxially oriented film is laminated on a metal sheet by use of an adhesive without using the heat fusion method, for not disturbing the biaxial orientation, and is subjected to the severe working as above-mentioned, the resin film may be broken at a strongly worked portion due to the small elongation or numerous cracks may be generated in the film.

In addition, if the adhesive force is poor, the resin film may peel during working.

Therefore, in the resin laminated metal sheets used for applications where the above-mentioned severe working is conducted, the biaxially oriented film is laminated on a metal sheet by use of the heat fusion method, whereby the biaxial orientation possessed by the film before lamination is partly or completely lost due to heating during the heat fusion of the film onto the metal sheet. The partial or complete removal of the biaxial orientation permits the film to have a lowered yield strength and an enhanced elongation after lamination onto the metal sheet, whereby peeling of the film, rupture of the film, and cracking of the film are prevented from being generated upon working.

However, the resin film having lost its orientation is high in permeability, so that the contents of the container may permeate the resin film, to corrode the metal substrate. Further, the film having lost the orientation has drawbacks in that coarse crystals may be produced upon heating in a printing step for indicating the contents of the container, enhancing the possibility of generation of cracks in the film when the container is dropped or when the containers collide on each other.

In view of this, as a resin laminated metal sheet to be applied to uses where the above-mentioned severe working is conducted, a resin laminated metal sheet obtained by laminating a polytrimethylene terephthalate (PTT) film excellent in impact resistance and the like to a metal sheet has been proposed.

For instance, Japanese Patent No. 3849826 (PTL 1) describes a film coated metal sheet in which a metal sheet is coated with a polytrimethylene terephthalate film having a low degree of crystallization and being non-oriented, whereby a resin coated metal formed body improved in impact resistance can be obtained. Specifically, at least one side of a metal sheet is coated with a polyester film containing polytrimethylene terephthalate as a main constituent, having a melting point of 190 to 230° C., having a low degree of crystallization of not more than 90% as determined by use of a differential scanning calorimeter (DSC), and being non-oriented.

In addition, Japanese Patent No. 3709869 (PTL 2) describes a polyester film which is improved in mechanical properties and in adhesion to a metal sheet and which is not susceptible to blushing even when heat treated at a temperature in the vicinity of or not lower than the melting point thereof. This polyester film is obtained by blending 10 to 90 wt. % of a polyester (A) containing ethylene terephthalate as a main constituent and 90 to 10 wt. % of a crystalline polyester (B) different from the polyester (A), and has a half width of a recrystallization peak in temperature fall determined by a differential scanning calorimeter (DSC) of not more than 0.25.

Note that the crystalline polyester (B) is described to be preferably a polyester selected from any of polybutylene terephthalate (PBT) type polyesters, polyethylene naphthalate (PEN) type polyesters, polytrimethylene terephthalate (PTT) type polyesters, polyhexamethylene terephthalate (PHT) type polyesters, and polypropylene terephthalate (PPT) type polyesters.

Furthermore, Japanese Patent No. 4288576 (PTL 3) describes a method of producing a resin coated metal sheet showing reduced neck-in at the time of melt extrusion, showing restrained generation of foreign matter in or on the molten resin film obtained, and showing restrained generation of defect as to flavor properties of the metal can and restrained generation of defective appearance (blushing of resin film) of the outer surface of the metal can upon hot-water sterilization after the metal can is filled with contents. The producing method is described to include a method wherein a molten resin film obtained in the state of joining of an olefin polymer at both end portions by use of a T-die is solidified by cooling, then both end portions are cut away to obtain a resin film (A) and a resin film (B), and a method wherein the resin film (A) and the resin film (B) are laminated on a heated metal sheet.

Here, the resin film (A) is described to include a polyester composed mainly of polytrimethylene terephthalate and an olefin polymer in a ratio of from 70:30 to 100:0 (wt. %), and the resin film (B) is described to include a polyester composed mainly of polytrimethylene terephthalate.

### CITATION LIST

### Patent Literatures

[PTL 1]

Japanese Patent No. 3849826

[PTL 2]

Japanese Patent No. 3709869

[PTL 3]

Japanese Patent No. 4288576

[PTL 4]

Japanese Patent No. 3124040

### SUMMARY

### Technical Problem

However, the resin films disclosed in the above-mentioned patent literatures cannot be said to be satisfactory as resin films for laminating on metal sheet having extremely high workability and applicable to uses where the resin films are subjected to severe working. For example, these resin films have a problem in that, for instance, in the case of raising the degree of ironing process for the purpose of further thinning the can wall thickness in order to reduce the can weight, the resin film cannot follow up to the deformation at the time of working and would peel from the metal sheet serving as a substrate.

Accordingly, it is an object of the present invention to provide: a resin film for laminating on metal sheet having extremely high workability and applicable to uses where the resin film is subjected to severe working such as drawing process, drawing and ironing process, thinning and drawing process, and, further ironing process after thinning and drawing process; a resin laminated metal sheet laminated with the resin film; and a container and a container lid that are worked by use of the resin laminated metal sheet.

### Solution to Problem

(1) A resin film for laminating on metal sheet of the present invention is characterized by including a polyester resin having such a mechanical property that a true stress at which a true strain of 1.0 as measured at 45° C. is obtained is 13 to 40 MPa.

(2) The resin film for laminating on metal sheet of the present invention is characterized in that in (1) above, the polyester resin is a material obtained by blending of a polybutylene terephthalate resin and a polytrimethylene terephthalate resin, and the polyester resin has a PTT resin content in the range from 20 to 80 mass %.

(3) A resin film for laminating on metal sheet of the present invention is characterized by being a two-layer resin film of the polyester resin of (1) above and a polyethylene terephthalate resin, wherein the thickness of the polyester resin layer is not less than one half the total resin layer thickness.

(4) The resin film for laminating on metal sheet of the present invention is characterized in that in (3) above, the polyester resin is a material obtained by blending of a polybutylene terephthalate resin and a polytrimethylene terephthalate resin, and the polyester resin has a PTT resin content in the range from 20 to 80 mass %.

(5) The resin film for laminating on metal sheet of the present invention is characterized in that in (3) or (4) above, the polyethylene terephthalate resin includes a copolymerized polyethylene terephthalate resin.

(6) A resin film for laminating on metal sheet of the present invention is characterized by including a three-layer resin film in which a copolymerized polyethylene terephthalate resin, the polyester resin of (1) above, and a polyethylene terephthalate resin are sequentially laminated, wherein the thickness of the polyester resin layer is not less than one half the total resin layer thickness.

(7) A resin film for laminating on metal sheet of the present invention is characterized by including a three-layer resin film in which a copolymerized polyethylene terephthalate resin, the polyester resin of (1) above, and a copolymerized polyethylene terephthalate resin are sequentially laminated, wherein the thickness of the polyester resin layer is not less than one half the total resin layer thickness.

(8) The resin film for laminating on metal sheet of the present invention is characterized in that in (6) or (7) above, the polyester resin is a material obtained by blending of a polybutylene terephthalate resin and a polytrimethylene terephthalate resin, and the polyester resin has a PTT resin content in the range from 20 to 80 mass %.

(9) A resin laminated metal sheet of the present invention is characterized in that the resin film for laminating on metal sheet described in (1) or (2) above is laminated on a metal sheet.

(10) A resin laminated metal sheet of the present invention is characterized in that the resin film for laminating on metal sheet including two layers described in any of (3) to (5) above is laminated on a metal sheet in such a manner that the polyester resin of (1) above, the blend resin of (2) above, or the copolymerized polyethylene terephthalate resin makes contact with the metal sheet.

(11) A resin laminated metal sheet of the present invention is characterized in that the resin film for laminating on metal sheet including three layers described in any of (6) to (8) above is laminated on a metal sheet in such a manner that either of the copolymerized polyethylene terephthalate resin layers makes contact with the metal sheet.

(12) A container of the present invention is characterized by being obtained by working the resin laminated metal sheet described in any of (9) to (11) above in such a manner that the resin film is located on an inner side.

(13) A container lid of the present invention is characterized by being obtained by working the resin laminated metal sheet described in any of (9) to (11) above in such a manner that the resin film is located on an inner side.

### Advantageous Effects of Invention

According to the present invention, a resin film has such a mechanical property that a true stress at which a true strain of 1.0 as measured at 45° C. is obtained is 13 to 40 MPa. Therefore, it is possible to provide a resin film for laminating on metal sheet having extremely high workability and applicable to uses where the resin film is subjected to severe working such as drawing process, drawing and ironing process, thinning and drawing process, and, further, ironing process after thinning and drawing process.

In addition, with the polyester resin of the resin film being a material obtained by blending of a polybutylene terephthalate resin (PBT) and a polytrimethylene terephthalate resin, and the polyester resin having a PTT resin content in the range from 20 to 80 mass %, the PBT and PTT are higher than polyethylene terephthalate resins (PET) in crystallization speed and, further, the blended resin of them has a higher crystallization speed, so that an inhibitive effect on retort blushing or the like can be expected.

Furthermore, a resin laminated metal sheet obtained by laminating the resin film on a metal sheet is excellent in adhesion, workability and durability.

Here, the retort blushing is a phenomenon in which when a can or can lid produced using a polyester film laminate material is subjected to a retort sterilization treatment (ordinarily, a treatment with steam at 120 to 130° C.), water droplets are adhered to the can or can lid, then the film layer having become amorphous through melting at the time of lamination is crystallized at water droplet adhesion portions, resulting in generation of white spot. The phenomenon damages the aesthetic appearance of the commercial product and is therefore deemed as very undesirable.

In the case where the crystallization speed of the resin in a polyester film laminate material is slow, crystals grow slowly, so that white spot is generated in the film and the retort blushing is worsened. On the contrary, in the case where the crystallization speed is high, a multiplicity of fine crystals are produced in the film, resulting in that white spot (retort blushing phenomenon) is largely improved, as is known (see JP 1993-331302 A).

In addition, by forming a resin film in a two-layer structure and providing a layer of PET or copolymerized PET as a surface layer of the two-layer resin film, it is possible to prevent a layer containing PBT, which is higher than PET in flavor component adsorptivity, from making direct contact with the contents. In this case, the two-layer resin film is applicable to uses where flavor properties are strictly demanded.

Furthermore, by forming a resin film in a three-layer structure and providing a layer of a copolymerized polyethylene terephthalate resin as a lower layer of the three-layer resin film, it is possible to enhance adhesion to a substrate (metal sheet), to enhance working adhesion, and to enhance durability to corrosion of the substrate and the like.

### BRIEF DESCRIPTION OF DRAWINGS

[FIG. 1]

FIG. 1 shows a true strain-true stress curve obtained in the case where a PBT resin and a PTT resin are blended in a ratio of 50:50.

[FIG. 2]

FIG. 2 is a graph showing variations in true stress in the case where a PTT resin is blended into a PBT resin.

[FIG. 3]

FIG. 3 shows illustrations of Embodiments of a resin laminated metal sheet of the present invention.

[FIG. 4]

FIG. 4 shows illustrations of other Embodiments of the resin laminated metal sheet of the present invention.

[FIG. 5]

FIG. 5 shows schematic configuration diagrams of resin layers of resin laminated metal sheets described in Examples.

### DESCRIPTION OF EMBODIMENTS

### Single-Layer Resin Film of Embodiment 1

A resin film according to Embodiment 1 is characterized by including a polyester resin having such a mechanical property that a true stress at which a true strain of 1.0 as measured at 45° C. is obtained is 13 to 40 MPa.

In the case where the true stress is less than 13 MPa, when a resin laminated metal sheet laminated with the resin film is worked and formed into a can, the coefficient of friction with forming tools such as a wrinkle presser and a punch is too high and uniform working is not achieved, resulting in that conspicuous surface roughening occurs on the resin film and the metal sheet. In addition, barrier property of the resin film is also lowered conspicuously, with an undesirable result that the metal sheet may be corroded when the resin laminated metal sheet is formed into a can, the can is filled with contents and the can with the contents is put to variation with time.

On the other hand, in the case where the true stress exceeds 40 MPa, it becomes impossible for the resin film to be perfectly laminated on the metal sheet, since the resin film may peel or may suffer generation of numerous cracks when the resin laminated metal sheet is subjected to severe working such as thinning and drawing process and, further, ironing process after thinning and drawing process.

Accordingly, the resin film is made to have such a mechanical property that a true stress at which a true strain of 1.0 as measured at 45° C. is obtained is 13 to 40 MPa. By this, it is ensured that when the resin laminated metal sheet laminated with the resin film is worked and formed into a can, uniform working can be achieved while lowering the coefficient of friction with forming tools such as a wrinkle presser and a punch, and conspicuous surface roughening can be prevented from occurring on the resin film or the metal sheet.

In addition, the resin laminated metal sheet can be formed into a can without lowering in the barrier property of the resin film, so that the metal sheet is not corroded when the can is filled with contents and the can with the contents is put to variation with time.

Furthermore, the resin film can be perfectly laminated on the metal sheet, as peeling of the resin film or cracking of the resin film would not occur when the resin laminated metal sheet is subjected to severe working.

### Thickness of Film

The thickness of the polyester resin film as above is preferably 5 to 50 μm, more preferably 10 to 30 μm. In the case where the thickness is less than 5 μm, wrinkling is liable to occur in the resin film when the resin film is fused onto the metal sheet, so that it is extremely difficult to stably laminate the resin film onto the metal sheet. When the thickness exceeds 50 μm, on the other hand, an economical advantage is lost, although the required properties are fulfilled.

Note that a colored film obtained by adding a colored pigment or the like to a molten polyester resin and forming the resin into a film at the time of film production may be used as the polyester resin film.

### Measuring Method for True Stress

A method for measuring true strain and true stress of a resin film will be described below.

A polyester resin film is blanked into a tensile specimen having a width of 5 mm and a length of 50 to 60 mm. The tensile specimen is put on a tensile tester (TENSILON) in which measurement environment is kept at 45° C., and measurement of a nominal stress-elongation percentage curve is conducted with a crosshead interval of 20 mm and a tensile speed of 200 mm/minute, to determine nominal stress σ₀ and elongation percentage El. The elongation percentage El can be obtained from the following formula.

El=100×(L−L₀)/L₀

where L₀ is the length of the specimen before applying tension, and
L is the length of the specimen after applying tension.

The true strain εa and true stress σa can be obtained from the following formulas.

[[εa=ε/(1+ε)]]εa=ln/(l+ε)σa=σ₀(1+ε)

where ε is strain, and ε=El/100.

The true strain and true stress obtained as above are plotted to form a true strain-true stress curve, and a true stress at which the true strain is 1.0 can be read from the curve. At the time of working for forming a can, the forming strain is not less than 1; in view of this, the value of the true stress is read on the basis of a true strain of 1.0 as a reference.

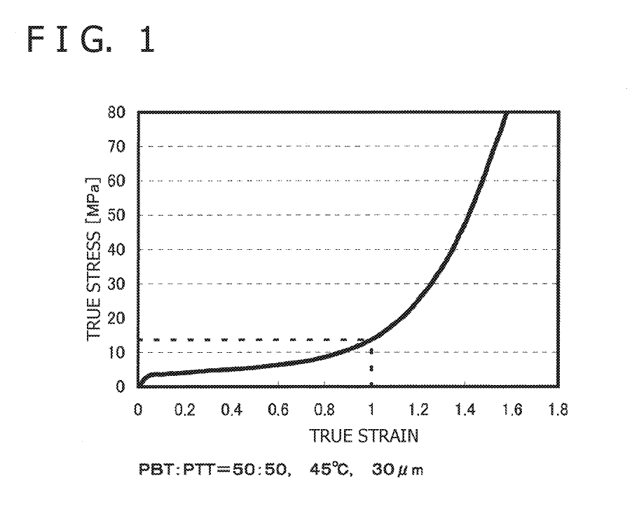

For example, FIG. 1 shows a true strain εa-true stress σa curve obtained in the case where a PTT resin is blended into a PBT resin in a ratio of 50:50.

As shown in FIG. 1, when the PTT resin is blended into the PBT resin in a ratio of 50:50, the value of true stress at which the true strain is 1.0 is read to be 13 MPa.

Such a true strain εa-true stress σa curve can be measured for the resin film according to Embodiment of the present invention, and the resin film is conditioned in such a manner that the value of a true stress at which a true strain of 1.0 as measured at 45° C. is obtained is in the range from 13 to 40 MPa, whereby good workability can be maintained.

### Single-Layer Resin Film of Embodiment 2

A resin film of Embodiment 2 is a resin film in which the polyester resin in Embodiment 1 is a blended resin of a polytrimethylene terephthalate resin (PTT) into a polybutylene terephthalate resin (PBT), with a PTT resin content in the range from 20 to 80 mass %.

### The Reason Why the PTT Resin is Blended in a Proportion of 20 to 80 Mass %

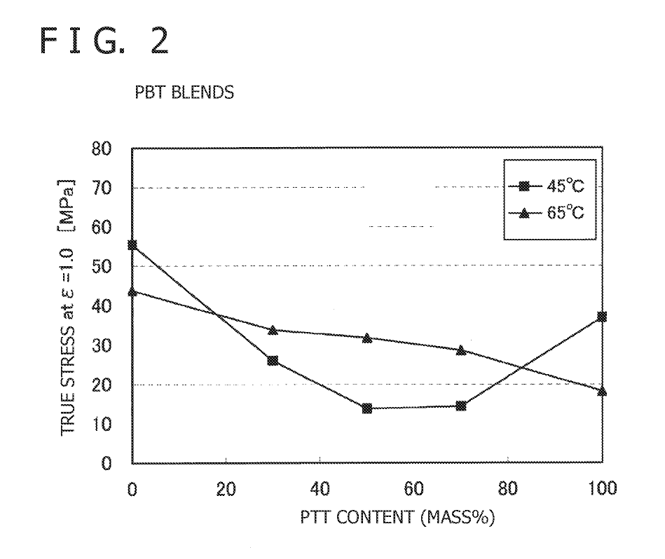

FIG. 2 is a graph showing variations in true stress in the case where a PTT resin is blended into a PBT resin.

In the resin film of Embodiment 2, the resin obtained by blending the PBT resin and the PTT resin has a PTT resin content in the range from 20 to 80 mass %.

In addition, a preferable PTT resin content is 30 to 70 mass %. A more preferable range is 40 to 60 mass %.

Specifically, as shown in FIG. 2, where the content of the PTT resin is 20 to 80 mass %, there is a range in which the true stress at 45° C. (in the vicinity of the glass transition temperature Tg) shows a minimum value, and the workability of the resin film in the vicinity of Tg is good.

As a result, when the PTT resin content in the blended resin of the PBT resin and the PTT resin is optimized, the true stress can be thereby lowered even in a temperature region in the vicinity of Tg, and a resin layer with good workability can be obtained.

In general, in the can manufacture industry, at the time of performing a severe forming process, the forming process is carried out at a temperature of not lower than the glass transition temperature of a resin film, in order to enhance the workability of the resin film.

As seen from FIG. 2, in the resin film of Embodiment 2, the true stress for the PBT resin alone without blending of the PTT resin therein (the proportion of PTT resin=0) is 55 MPa at a working temperature of 45° C. but is as low as 44 MPa at a working temperature of 65° C.

However, while the Tg (glass transition temperature) is in the vicinity of 45° C. for both the PBT resin and PTT resin, when the blending ratio of the PTT resin to the PBT resin is gradually increased (rightward movement along the axis of abscissas), the value of true stress is gradually lowered both at a working temperature of 45° C. and at a working temperature of 65° C.

For example, when the PBT-PTT blending ratio is 50:50, the true stress is 13 MPa.

From the results shown in FIG. 2, it is seen that where the PBT-PTT blending ratio is in the region of PTT resin content in the range from 20 to 80 mass %, the true stress at a working temperature of 45° C. has a minimum region in which the true stress at 45° C. is lower than the true stress at 65° C. In other words, where the PTT resin content is in the region of 20 to 80 mass %, working with a stress smaller than the stress value needed at or above Tg can be performed at 45° C. in the vicinity of Tg.

Accordingly, from the results of FIG. 2, it is seen that the workability in the vicinity of Tg is good when the PTT resin content is set to be 20 to 80 mass %, preferably 30 to 70 mass %, more preferably 40 to 60 mass %.

In general, in the case where a forming process is conducted at a temperature region higher than Tg, problems of generation of adhesion to tools or the like, surface roughening of the resin layer and the like are liable to occur. In order to secure workability, however, it is necessary to raise the working temperature to thereby lower the true stress. Therefore, it has been indispensable to set the temperature in such a manner as to obtain a good balance of these factors.

Accordingly, by blending the PTT resin into the PBT resin and optimizing the PTT resin content, as aforementioned, it has become possible to lower the true stress even in the temperature region in the vicinity of Tg, and, as a result, it has become possible to obtain a resin film having good workability.

In addition, it has been found that the workability-enhancing effect owing to the PBT-PTT blend resin as above can be sufficiently obtained not only in a film composed of a single layer of the blended resin but also when the blended resin film is provided as at least one layer in a resin film composed of a plurality of layers. It cannot be said that details of this mechanism have become elucidated; however, it is supposed that the provision of a layer with a low true stress offers a stress-dispersing effect at the time of working, thereby leading to enhanced workability of the film as a whole.

### Two-Layer Resin Film of Embodiment 3

A resin film of Embodiment 3 is a two-layer resin film of the polyester resin of Embodiment 1 and a polyethylene terephthalate resin (PET), wherein the thickness of the polyester resin layer is not less than one half the total resin layer thickness.

By this, a two-layer resin film which maintains surface properties can be obtained. When the thickness of the polyester resin layer is less than one half the total resin layer thickness, it may become impossible for the resin film to be perfectly laminated on the metal sheet, since peeling of the resin film or generation of cracks in the resin film may occur when severe working is conducted. Such a situation is undesirable.

### Two-Layer Resin Film of Embodiment 4

A resin film of Embodiment 4 is a resin film in which the polyester resin of the resin film in Embodiment 3 is a blended resin of a polytrimethylene terephthalate resin (PTT) into a polybutylene terephthalate resin (PBT) with a PTT resin content in the range from 20 to 80 mass %. With the blend of the polytrimethylene terephthalate resin (PTT) into the polybutylene terephthalate resin (PBT) used as the polyester resin of the two-layer resin, the resin film shows a workability-enhancing effect, and this resin, in cooperation with the polyethylene terephthalate resin (PET) laminated, is suitable as a material for cans and can lids.

### Two-Layer Resin Film of Embodiment 5

A resin film of Embodiment 5 is a resin film in which the polyethylene terephthalate resin (PET) of the resin film in Embodiment 3 or 4 includes a copolymerized polyethylene terephthalate resin (PET/IA) in which isophthalic acid is copolymerized as an acid component.

With the copolymerized polyethylene terephthalate resin used, adhesion to the substrate (metal sheet) can be enhanced. As a result, even at the time of severe working, peeling of the resin film does not occur, and breakage of the resin film and cracking of the film can be prevented from occurring.

### Three-Layer Resin Film of Embodiment 6

A resin film of Embodiment 6 is a resin film of sequentially laminated three layers composed of a copolymerized polyethylene terephthalate resin (PET/IA), the polyester resin of Embodiment 1, and a polyethylene terephthalate resin (PET), wherein the thickness of the polyester resin layer is not less than one half the total resin layer thickness.

The resin film composed of the polyester resin at the intermediate position has the workability-enhancing effect, and this film, in cooperation with the copolymerized polyethylene terephthalate resin (PET/IA) and the polyethylene terephthalate resin (PET) laminated, is suitable as a material for cans and can lids.

### Three-Layer Resin Film of Embodiment 7

A resin film of Embodiment 7 includes sequentially laminated three layers composed of a copolymerized polyethylene terephthalate resin (PET/IA), the polyester resin of Embodiment 1, and a copolymerized polyethylene terephthalate resin (PET/IA), wherein the thickness of the polyester resin layer is not less than one half the total resin layer thickness.

The resin film composed of the polyester resin at the intermediate position has the workability-enhancing effect, and this film, in cooperation with the copolymerized polyethylene terephthalate resin (PET/IA) laminated, is suitable as a material for cans and can lids.

### Three-Layer Resin Film of Embodiment 8

A resin film of Embodiment 8 is a resin film in which the polyester resin of Embodiment 6 or 7 is a blended resin of a polytrimethylene terephthalate resin (PTT) into a polybutylene terephthalate resin (PBT) with a PTT resin content in the range from 20 to 80 mass %.

The resin film composed of the polyester resin at the intermediate position, namely, a blended resin of a polytrimethylene terephthalate resin (PTT) into a polybutylene terephthalate resin (PBT), has the workability-enhancing effect, and this film, in cooperation with the surface properties of the polyethylene terephthalate resin (PET) (inclusive of the copolymerized one) laminated and the adhesion properties of the resin film, is suitable as a material for cans and can lids.

### Method for Producing Film

In the production of the resin films of Embodiments 1 to 8, a resin composition for constituting the resin film is used after mixed, melted and kneaded.

Melt kneaders ordinarily used can be used for the mixing, melting and kneading, the use of a twin-screw extruder is preferable because the resin composition can be formed into a resin film while being kneaded.

Alternatively, the resin composition may be kneaded and extruded into a strand by a twin-screw extruder, the strand may be pelletized, and the pellets may be used.

The resin films obtained by an extruder can be laminated by a generally known method. For example, a first layer and a second layer can be laminated by dry lamination using an adhesive.

In addition, an extrusion lamination method can be adopted in which a second layer is extruded onto a resin film of a first layer, thereby forming a laminated resin film.

Further, the resin film can be produced by a co-extrusion method in which layers are simultaneously extruded using three or more extruders and are laminated in a feed block or a die. Among these methods, the co-extrusion method is most preferable because this method can produce the resin film by one time extrude, which is high efficiency. For the co-extrusion method, both a T-die method and a circular die method can be used.

Note that the laminated resin film may be a film stretched after formed into a film by extrusion. In that case, the orientation of the film generated in the stretching process must be lowered at the time of lamination onto the metal sheet by heat fusion, thereby preparing the film to have a mechanical property within the range as described in claim 1.

### Resin Laminated Metal Sheet of Embodiment 9

A resin laminated metal sheet of Embodiment 9 will be described below.

The resin laminated metal sheet of Embodiment 9 is obtained by laminating a resin film or films of Embodiment 1 or 2 onto one side or both sides of a metal sheet, with or without an adhesive therebetween.

The resin laminated metal sheet of Embodiment 9 shows excellent adhesion to the metal sheet serving as a substrate, even in the case where the resin laminated metal sheet is formed into a container by severe working such as drawing process, drawing and ironing process, thinning and drawing process, and, further, ironing process after thinning and drawing process. In addition, the resin laminated metal sheet is free from inter-layer exfoliation of the resin film or peeling between the resin film and the substrate even upon working. Thus, the resin laminated metal sheet can be worked and formed into cans and can lids which are excellent in quality.

### Description of Metal Sheet

The metal sheet for use in the resin laminated metal sheet of Embodiment 9 will be described below.

As a metal sheet to be a substrate on which to laminate the resin film, a belt-shaped surface-treated steel sheet or aluminum alloy sheet is used. In the case of using a steel sheet, the chemical components of the steel are not particularly limited so long as the steel sheet can be subjected to the above-mentioned severe working in forming. However, it is preferable that the steel sheet is a low-carbon cold rolled steel sheet having a thickness of 0.15 to 0.30 mm. It is more preferable that the steel sheet is a steel sheet provided on its surface with a hydrated chromium oxide film for securing excellent working adhesion between itself and the resin film laminated thereon, particularly, a steel sheet provided with a film of two-layer structure having a lower layer of metallic chromium and an upper layer of hydrated chromium oxide, namely, the so-called tin free steel (TFS). Furthermore, a steel sheet provided on its surface with a multilayer plating or alloy plating of one or more of tin, nickel, aluminum and the like and further provided thereon with the above-mentioned two-layer structured film can also be applied as the steel sheet.

In the case of an aluminum alloy sheet, the chemical components of the alloy are not particularly limited so long as the alloy sheet can be subjected to severe working in forming, like the steel sheet. However, 3000 series and 5000 series aluminum alloy sheets are preferable from the viewpoint of cost and workability in forming. It is more preferable that the aluminum alloy sheet is an aluminum alloy sheet surface-treated by a known method such as an electrolytic chromic acid treatment, an immersion chromic acid treatment, a phosphoric acid-chromic acid treatment, an etching treatment with an alkaline solution or acid solution, an anodic oxidation treatment, etc.

Particularly, in the case where the above-mentioned two-layer film including a lower layer of metallic chromium and an upper layer of hydrated chromium oxide is formed on the steel sheet or aluminum alloy sheet, the amount of the hydrated chromium oxide as chromium is preferably in the range of 3 to 50 mg/m², more preferably 7 to 25 mg/m², from the viewpoint of the working adhesion of the polyester resin film laminated on the metal sheet.

Besides, the amount of metallic chromium need not be particularly limited. From the viewpoint of corrosion resistance after working and working adhesion of the resin film laminated on the metal sheet, however, the amount of metallic chromium is preferably in the range of 10 to 200 mg/m², more preferably 30 to 100 mg/m².

### Metal Sheet Laminating Method

A method of producing the resin laminated metal sheet of Embodiment 9 will be described below.

A metal sheet continuously fed out from metal sheet supply means is heated by heating means to a temperature not lower than the melting point of a resin, a resin film or films fed out from film supply means are brought into one side or both sides of the metal sheet, and the film or films and the metal sheet are laid on one another and clamped and press bonded to one another between a pair of laminating rolls, to laminate them, followed immediately by rapid cooling.

The cooling rate is determined by the temperature of the metal sheet, the temperature of the laminating rolls, the duration of contact of the resin laminated metal sheet with the laminating rolls, namely, the feeding-out speed of the metal sheet, and the length of the part of contact between the laminating rolls and the laminated metal sheet (the nip, which is determined by the diameter of the laminating rolls and the modulus of elasticity of the rolls).

Besides, in the present invention, at the time of laminating the resin film or films onto the metal sheet or at the time of laminating resin films on one another, an adhesive as described below may be interposed between the resin film and the metal sheet.

### Adhesive

As an adhesive to be used for laminating resin films on one another or laminating the resin film on the metal sheet, general adhesives such as emulsion type adhesives based on polyester, acrylic compound, vinyl acetate resin, ethylene-vinyl acetate resin, urea resin, urethane resin or the like are preferably used because they are safe in relation with fire, odorless and inexpensive.

Other than the above-mentioned, emulsion type adhesives based on polyester urethane resin or the like, thermosetting type adhesives based on epoxy-phenolic resin or the like, polyester urethane resin adhesives and the like can also be used.

Note that the adhesive is not to be limited to these mentioned ones.

### Resin Laminated Metal Sheet of Embodiment 10

Resin laminated metal sheets of Embodiment 10 will be described below.

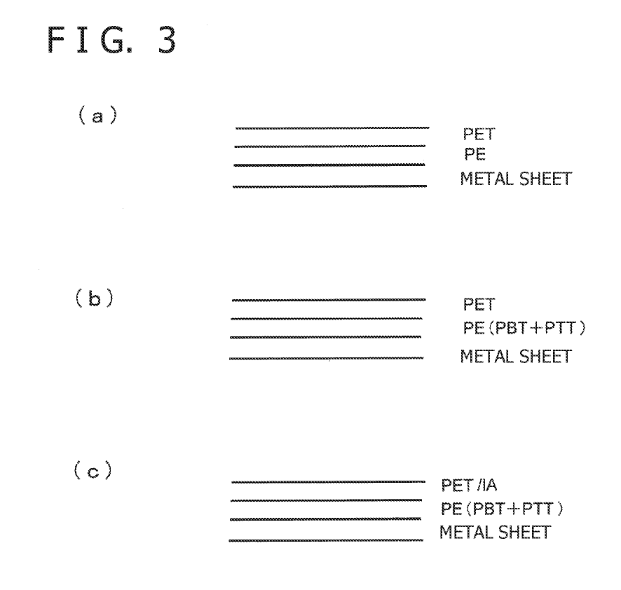

FIG. 3 illustrates configurations of resin laminated metal sheets in each of which one of the two-layer resin films of Embodiments 3 to 5 is laminated on a metal sheet.

The resin laminated metal sheet of Embodiment 10 is obtained by laminating the two-layer resin film of any one of Embodiments 3 to 5 on a metal sheet in such a manner that the polyester resin makes contact with the metal sheet.

FIG. 3(a) is an illustration of a state in which the resin film for laminating on metal sheet of Embodiment 3 is laminated on a metal sheet. As shown in FIG. 3(a), the polyester resin of the resin film is contacted to the metal sheet.

FIG. 3(b) is an illustration of a state in which the resin film for laminating on metal sheet of Embodiment 4 is laminated on a metal sheet. As shown in FIG. 3(b), the resin obtained by blending a polytrimethylene terephthalate resin (PTT) into a polybutylene terephthalate resin (PBT) is contacted to the metal sheet.

FIG. 3(c) is an illustration of a state in which the resin film for laminating on metal sheet of Embodiment 5 is laminated on a metal sheet. As shown in FIG. 3(c), the resin obtained by blending a polytrimethylene terephthalate resin (PTT) into a polybutylene terephthalate resin (PBT) is contacted to the metal sheet.

In any of these, the resin film having workability and surface characteristics is laminated, and, accordingly, excellent cans and can lids free of film peeling, cracking or the like upon working can be obtained.

### Resin Laminated Metal Sheet of Embodiment 11

Resin laminated metal sheets of Embodiment 11 will be described below.

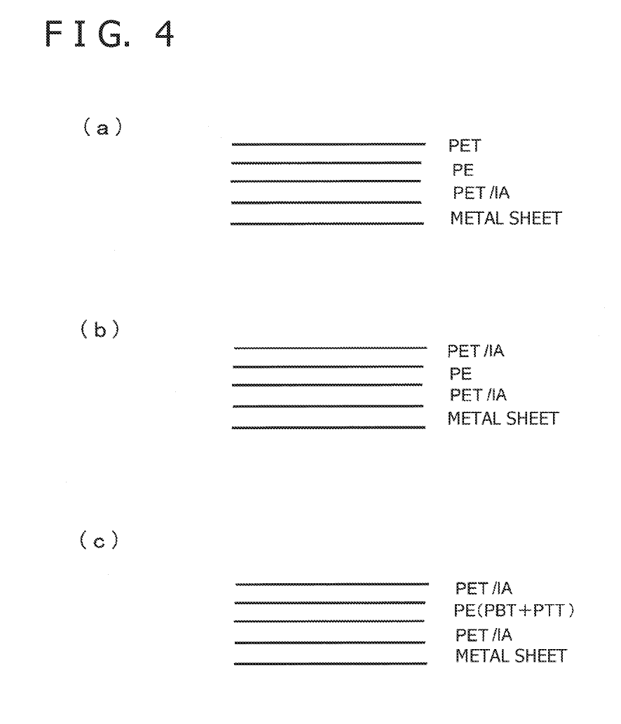

FIG. 4 illustrates configurations of resin laminated metal sheets in each of which one of the three-layer resin films of Embodiments 6 to 8 is laminated on a metal sheet.

The resin laminated metal sheet of Embodiment 11 is obtained by laminating the three-layer resin film of any one of Embodiments 6 to 8 on a metal sheet in such a manner that either of the copolymerized polyethylene terephthalate resins (PET/IA) makes contact with the metal sheet.

FIG. 4(a) is an illustration of a state in which the resin film for laminating on metal sheet of Embodiment 6 is laminated on a metal sheet. As shown in FIG. 4(a), the copolymerized polyethylene terephthalate resin (PET/IA) of the resin film is contacted to the metal sheet.

FIG. 4(b) is an illustration of a state in which the resin film for laminating on metal sheet of Embodiment 7 is laminated on a metal sheet. As shown in FIG. 4(b), the copolymerized polyethylene terephthalate resin (PET/IA) is contacted to the metal sheet.

FIG. 4(c) is an illustration of a state in which the resin film for laminating on metal sheet of Embodiment 8 is laminated on a metal sheet. As shown in FIG. 4(c), the copolymerized polyethylene terephthalate resin (PET/IA) is contacted to the metal sheet, wherein the resin obtained by blending a polytrimethylene terephthalate resin (PTT) into a polybutylene terephthalate resin (PBT) is interposed as an intermediate layer between the layers of the copolymerized polyethylene terephthalate resin (PET/IA).

In any of these, the resin film having workability and surface characteristics is laminated, and, accordingly, cans and can lids free of film peeling or cracking upon working can be obtained.

### Container of Embodiment 12

A container of Embodiment 12 is a container obtained by working the resin laminated metal sheet of any of Embodiments 9 to 11 in such a manner that the laminated resin film is located on an inner side of the container.

As the container, in general, a seamless can (two piece can) may be mentioned. The container is produced by subjecting the resin laminated metal sheet to conventionally known means such as a drawing and redrawing process, a bending and stretching process (stretching process) by drawing and redrawing, a bending and stretching and ironing process or drawing and ironing process by drawing and redrawing, etc., in such a manner that the coating surface of the polyester resin is located on the inner surface side of the can.

In addition, the can may be a two piece can used by winding and fastening a lid after formation of a neck, or may be a bottle type can used by capping after multi-step neck working and screw working.

In the case of the bottle type can, it may be a three piece type can wherein a shell lid is wound and fastened at a bottom portion and capping is conducted at a can top portion.

In a preferable production method of a seamless can, a resin laminated metal sheet is cut into a circular shape, and the circular sheet is subjected to drawing by use of a combination of a drawing die and a drawing punch to form a shallow drawn cup. The shallow drawn cup is subjected repeatedly to simultaneous drawing and ironing process in which ironing is conducted while drawing in the same die, to form a cup having a small diameter and a large height.

In this forming method, deformation for thinning is conducted by carrying out deformation (bending and stretching) by a load in the can axis direction (height direction) and deformation (ironing) by a load in the can thickness direction in combination and in this order, whereby a molecular orientation in the can axis direction is advantageously imparted.

Thereafter, doming, a heat treatment for the purpose of removing residual strain of the coating resin generated due to working, subsequent trimming of an opening end portion, curved-surface printing, neck-in working, and flange working are conducted, to produce a can.

### Container Lid of Embodiment 13

A container lid of Embodiment 13 is a can lid formed from the resin laminated metal sheet of any of Embodiments 9 to 11 by a known forming method such as press forming in which the resin laminated metal sheet is formed in such a manner that the resin film is located on the inner side of the container.

As the container lid (can lid), there may be mentioned a stay-on-tab type easy-open can lid and a so-called full-open type easy-open can lid. As a method for producing the container lid (can lid), a conventionally known arbitrary can manufacturing method may be applied.

A full-open type easy-open can lid is provided on an outer circumferential side with a sealing groove through an annular rim portion (countersink) to be fitted to the inner surface of a side surface of a can barrel, and is provided on the inner side of the annular rim portion with a score which is formed over the whole circumference for partitioning the part to be opened.

In the inside of the part to be opened, there are formed a substantially semicircular recessed portion panel formed by pushing in a substantially central portion, a dimple formed by projecting a lid material to the periphery of the recessed portion panel, and a rivet formed by projecting the lid material to the outer surface side of the can lid, and an opening tab is fixed by riveting of the rivet.

The opening tab has an opening tip for push tearing at one end, and a retainer ring at the other end. In the vicinity of the rivet, a breakage starting score arranged discontinuously from the score is formed on the opposite side of the score.

At the time of opening, the ring of the opening tab is grasped, and is lifted upward.

By this, the breakage starting score is broken, the opening tip of the opening tab is pushed in downward comparatively largely, and shearing of part of the score is started.

Next, the ring is pulled upward, whereby the residual part of the score is broken over the whole circumference, and opening is achieved easily.

In a method of producing an easy-open can lid, a resin laminated metal sheet is blanked in a circular shape by a press forming step and is formed into a can lid shape. A lining step is conducted by lining a sealing groove with a compound and drying the compound. A score cutting step is conducted to cut a score such as to reach an intermediate position of the metal material from the outer surface side of the lid. Then, formation of a rivet, attaching a tab to the rivet, and attaching the tab by riveting of the rivet, are conducted to produce an easy-open can lid.

### EXAMPLES

The present invention will be described more in detail below by use of Examples.

### Example 1

A thermally melted blended resin of a polytrimethylene terephthalate resin (PTT) into a polybutylene terephthalate resin (PBT) (PTT resin content: 80 mass %) was extruded through a T-die of an extruder onto a casting roll, to form a single-layer resin film having a thickness of 50 μm.

The resin film was laminated on both sides of a substrate (tin free steel (TFS)) through an adhesive, to obtain a resin laminated metal sheet.

Next, the resin laminated metal sheet was blanked into a blank, which was subjected to a drawing and ironing process at a working temperature of 45° C. By this, a good can free of peeling of the resin film could be obtained, and usability as a container could be confirmed.

In producing the container, the resin laminated metal sheet was worked by a drawing and ironing method to form a bottomed cylindrical can in the following manner.

The resin laminated metal sheet was blanked into a 150 mm blank, which was formed into a drawn can having a can bottom diameter of 100 mm, with the polyester resin film coated surface on the inside of the can.

Next, redrawing was conducted to obtain a redrawn can having a can bottom diameter of 80 mm.

Further, the redrawn can was subjected to composite working in which stretching and ironing were simultaneously conducted, to obtain a drawn and ironed can having a can bottom diameter of 65 mm.

The composite working was conducted under the conditions wherein the interval between a redrawn portion to be a can top portion and an ironing part was 20 mm, the R at the shoulder of a redrawing die was 1.5 times the sheet thickness, the clearance between the redrawing die and the punch was 1.0 times the sheet thickness, and the clearance of the ironing part was 40% of the original sheet thickness.

Subsequently, the can top portion was trimmed, and neck-in working and flange working were carried out by known methods.

In addition, for a container lid, the substrate was changed from TFS to aluminum, and the same resin film as that for the container was laminated on one side of the aluminum substrate, to produce a resin laminated metal sheet.

Thereafter, the resin laminated metal sheet was worked by a press forming method to form a 200 diameter SOT lid (can lid), with the resin film on the inside of the container, and usability thereof as a container lid could be confirmed.

### Example 2

A thermally melted blended resin of a polytrimethylene terephthalate resin (PTT) into a polybutylene terephthalate resin (PBT) (PTT resin content: 20 mass %) was extruded through a T-die of an extruder onto a casting roll, to form a single-layer resin film having a thickness of 25 μm.

The resin film was laminated on both sides of a substrate (TFS), without any adhesive interposed therebetween.

Next, drawing and ironing process was conducted at a working temperature of 45° C. in the same manner as in Example 1, to obtain a result similar to the above.

### Example 3

A polyester resin having such a mechanical property that a true stress at which a true strain of 1.0 as measured at 45° C. is obtained is 13 MPa and a polyethylene terephthalate resin (PET) were extruded by co-extrusion through a T-die onto a casting roll, to produce a two-layer resin film including the polyester resin having a thickness of 15 μm and the polyethylene terephthalate resin (PET) having a thickness of 15 μm (the thickness of the polyester resin layer was one half the total resin layer thickness).

The two-layer resin film was laminated on both sides of a substrate (TFS) through an adhesive, with the polyester resin in contact with the substrate.

Next, drawing and ironing process was conducted at a working temperature of 45° C. in the same manner as in Example 1, to obtain a result similar to the above.

### Example 4

As the polyester resin of Example 3, a blended resin of a polytrimethylene terephthalate resin (PTT) into a polybutylene terephthalate resin (PBT) (PTT resin content: 50 mass %) was prepared. This polyester resin and a polyethylene terephthalate (PET/IA) resin copolymerized with 15 mol % of isophthalic acid serving as an acid component were extruded by co-extrusion through a T-die of an extruder onto a casting roll, to produce a two-layer resin film including a polyester resin film having a thickness of 15 μm and the copolymerized polyethylene terephthalate resin (PET/IA) having a thickness of 10 μm (the thickness of the polyester resin layer was not less than one half the total resin layer thickness).

This resin film was laminated on both sides of a substrate (TFS) without any adhesive therebetween, in such a manner that the copolymerized polyethylene terephthalate resin (PET/IA) was in contact with the substrate.

Next, drawing and ironing process was conducted at a working temperature of 45° C. in the same manner as in Example 1, to obtain a result similar to the above.

### Example 5

Like in Example 4, as the polyethylene terephthalate resin (PET), a polyethylene terephthalate resin (PET/IA) copolymerized with 15 mol % of isophthalic acid serving as an acid component was prepared. Separately, a blended resin of a polytrimethylene terephthalate resin (PTT) into a polybutylene terephthalate resin (PBT) (PTT resin content: 50 mass %) was prepared. The copolymerized polyethylene terephthalate resin (PET/IA) and the resin composition were extruded by co-extrusion through a T-die of an extruder onto a casting roller, to produce a two-layer resin film including the copolymerized polyethylene terephthalate resin (PET/IA) having a thickness of 10 μm and the PBT-PTT blend resin having a thickness of 10 μm (the thickness of the PBT-PTT blend resin layer was one half the total resin layer thickness).

This resin film was laminated on both sides of a substrate (TFS) through an adhesive therebetween in such a manner that the PBT-PTT blend resin was in contact with the substrate.

Next, drawing and ironing process was conducted at a working temperature of 45° C. in the same manner as in Example 1, to obtain a result similar to the above.

### Example 6

A polyethylene terephthalate (PET/IA) resin copolymerized with 15 mol % of isophthalic acid serving as an acid component, a blended resin of a polytrimethylene terephthalate resin (PTT) into a polybutylene terephthalate resin (PBT) (PTT resin content: 50 mass %), and a polyethylene terephthalate resin (PET) were prepared, and they were extruded by co-extrusion through a T-die of an extruder onto a casting roll, to produce a three-layer resin film sequentially including the copolymerized polyethylene terephthalate resin (PET/IA) having a thickness of 10 μm, the polyester resin having a thickness of 20 μm, and the polyethylene terephthalate resin (PET) having a thickness of 10 μm (the ratio of the thickness of the polyester resin layer at an intermediate position to the total resin layer thickness was 20/40).

This resin film was laminated on both sides of a substrate (TFS) without any adhesive therebetween, in such a manner that the copolymerized polyethylene terephthalate resin (PET/IA) was in contact with the substrate.

Next, drawing and ironing process was conducted at a working temperature of 45° C. in the same manner as in Example 1, to obtain a result similar to the above.

### Example 7

A polyethylene terephthalate resin (PET/IA) copolymerized with 10 mol % of isophthalic acid serving as an acid component, a blended resin of a polytrimethylene terephthalate resin (PTT) into a polybutylene terephthalate resin (PBT) (PTT resin content: 50 mass %), and a polyethylene terephthalate resin (PET/IA) copolymerized with 15 mol % of isophthalic acid serving as an acid component, were prepared, and they were extruded by co-extrusion through a T-die of an extruder onto a casting roll, to produce a three-layer resin film including sequentially the 10 mol % copolymerized polyethylene terephthalate resin (PET/IA) having a thickness of 5 μm, the polyester resin having a thickness of 20 μm, and the 15 mol % copolymerized polyethylene terephthalate resin (PET/IA) having a thickness of 5 μm (the ratio of the thickness of the polyester resin layer at the intermediate position to the total resin layer thickness was 20/30).

This resin film was laminated on both sides of a substrate (TFS) without any adhesive therebetween in such a manner that the 15 mol % copolymerized polyethylene terephthalate resin (PET/IA) was in contact with the substrate.

Next, drawing and ironing process was conducted at a working temperature of 45° C. in the same manner as in Example 1, to obtain a result similar to the above.

### Example 8

A polyethylene terephthalate resin (PET/IA) copolymerized with 5 mol % of isophthalic acid serving as an acid component, a blended resin of a polytrimethylene terephthalate resin (PTT) into a polybutylene terephthalate resin (PBT) (PTT resin content: 50 mass %), and a polyethylene terephthalate resin (PET/IA) copolymerized with 20 mol % of isophthalic acid serving as an acid component, were prepared, and they were extruded by co-extrusion through a T-die of an extruder onto a casting roll, to produce a three-layer resin film including sequentially the 5 mol % copolymerized polyethylene terephthalate resin (PET/IA) having a thickness of 5 μm, the PBT-PTT blend resin having a thickness of 15 μm, and the 20 mol % copolymerized polyethylene terephthalate resin (PET/IA) having a thickness of 5 μm (the ratio of the thickness of the PBT-PTT blend resin layer at the intermediate position to the total resin layer thickness was 15/25).

This resin film was laminated on both sides of a substrate (aluminum) without any adhesive therebetween in such a manner that the 20 mol % copolymerized polyethylene terephthalate resin (PET/IA) was in contact with the substrate.

Next, drawing and ironing process was conducted at a working temperature of 45° C. in the same manner as in Example 1, to obtain a result similar to the above.

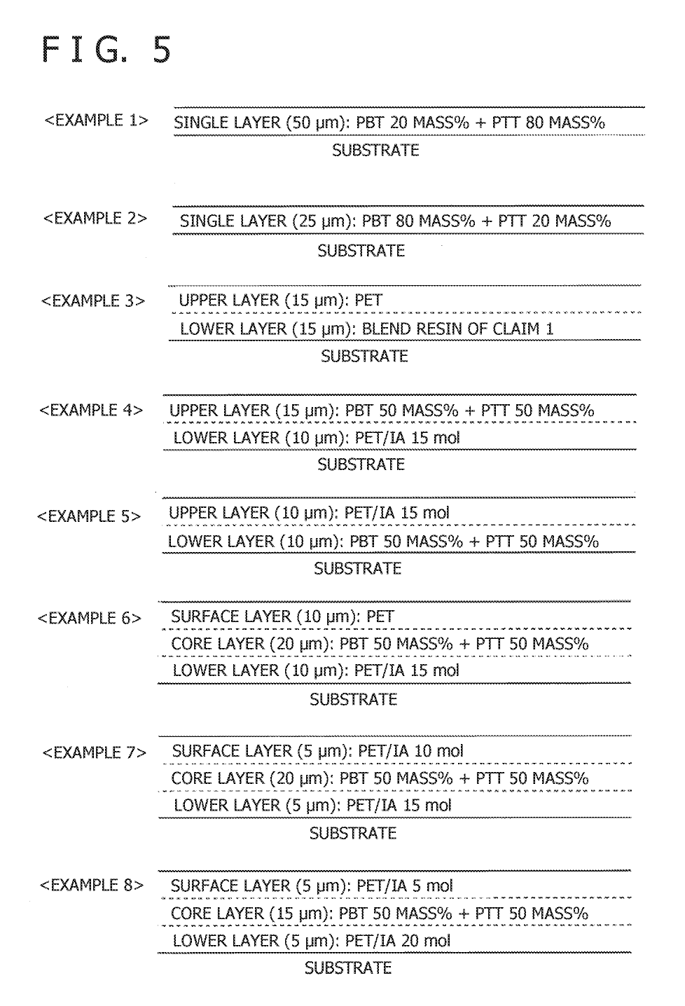

Schematic diagrams of the resin laminated metal sheets described in Examples 1 to 8 are shown in FIG. 5.

### INDUSTRIAL APPLICABILITY

The resin film for laminating on metal sheet of the present invention has such a resin film mechanical property that a true stress at which a true strain of 1.0 as measured at 45° C. is obtained is 13 to 40 MPa, and, accordingly, can be a resin film for laminating on metal sheet having extremely high workability and applicable to such uses as to be subjected to severe working such as drawing process, drawing and ironing process, thinning and drawing process, and, further, ironing process after thinning and drawing process. Thus, the resin film for laminating on metal sheet of the present invention has an extremely high industrial applicability.

1. A resin film for laminating on metal sheet comprising a three-layer resin film in which a first copolymerized polyethylene terephthalate resin, a polyester resin, and a second copolymerized polyethylene terephthalate resin are sequentially laminated,
the polyester resin having such a mechanical property that a true stress at which a true strain of 1.0 as measured at 45° C. is obtained is 13 MPa to 40 MPa,
wherein the thickness of the polyester resin layer is not less than one half the total resin layer thickness.

2. A resin film for laminating on metal sheet, according to claim 1,
wherein the thickness of the polyester resin layer is 5 to 50 μm.

3. A resin film for laminating on metal sheet, according to claim 1,
wherein the thickness of the first copolymerized polyethylene terephthalate resin is substantially equal to the thickness of the second copolymerized polyethylene terephthalate resin.

4. A resin film for laminating on metal sheet, according to claim 1,
wherein the first copolymerized polyethylene terephthalate resin is more copolymerized than the second copolymerized polyethylene terephthalate resin.

5. A resin film for laminating on metal sheet, according to claim 4,
wherein the first copolymerized polyethylene terephthalate resin is a polyethylene terephthalate (PET/IA) resin copolymerized with 15 to 20 mol % of isophthalic acid.

6. A resin film for laminating on metal sheet, according to claim 4,
wherein the second copolymerized polyethylene terephthalate resin is a polyethylene terephthalate (PET/IA) resin copolymerized with 5 to 10 mol % of isophthalic acid.

7. A resin film for laminating on metal sheet, according to claim 1,
wherein the polyester resin includes 20 to 80 mass % of a polytrimethylene terephthalate resin (PTT) blended into a polybutylene terephthalate resin (PBT).

8. A resin film for laminating on metal sheet, according to claim 7,
wherein the polyester resin is consisting 50 mass % of the PTT and 50 mass % of the PBT.

9. A resin laminated metal sheet, comprising:
a metal sheet,
a resin film according to claim 1, the resin film being laminated on the metal sheet,
wherein the first copolymerized polyethylene terephthalate resin of the resin film contacts the metal sheet.

10. A resin laminated metal sheet, according to claim 9,
wherein the first copolymerized polyethylene terephthalate resin of the resin film contacts the metal sheet via an adhesive therebetween.

11. A resin laminated metal sheet, according to claim 9,
wherein the thickness of the polyester resin layer is 5 to 50 μm.

12. A resin laminated metal sheet, according to claim 9,
wherein the thickness of the first copolymerized polyethylene terephthalate resin is substantially equal to the thickness of the second copolymerized polyethylene terephthalate resin.

13. A resin laminated metal sheet, according to claim 9,
wherein the first copolymerized polyethylene terephthalate resin is more copolymerized than the second copolymerized polyethylene terephthalate resin.

14. A resin laminated metal sheet, according to claim 13,
wherein the first copolymerized polyethylene terephthalate resin is a polyethylene terephthalate (PET/IA) resin copolymerized with 15 to 20 mol % of isophthalic acid.

15. A resin laminated metal sheet, according to claim 13,
wherein the second copolymerized polyethylene terephthalate resin is a polyethylene terephthalate (PET/IA) resin copolymerized with 5 to 10 mol % of isophthalic acid.

16. A container lid obtained by working a resin laminated metal sheet, having a resin film laminated on a metal sheet, in such a manner that the resin film is located on an inner side of the container lid,
the resin film comprising a polyester resin having such a mechanical property that a true stress at which a true strain of 1.0 as measured at 45° C. is obtained is 13 MPa to 40 MPa.

17. A container lid, according to claim 16,
wherein the polyester resin includes 20 to 80 mass % of a polytrimethylene terephthalate resin (PTT) blended into a polybutylene terephthalate resin (PBT).

18. A container lid, according to claim 17,
wherein the polyester resin is consisting 50 mass % of the PTT and 50 mass % of the PBT.

19. A container lid, according to claim 16, further comprising:
a first copolymerized polyethylene terephthalate resin configured to intermediate between the resin film and the metal sheet.

20. A container lid, according to claim 19, further comprising:
a polyethylene terephthalate resin which is formed on the resin film.
